(19) United States
(12) Patent Application Publication
(10) Pub. No.: US 2015/0314155 A1
(43) Pub. Date: Nov. 5, 2015

(54) Treatment of Sodic Fly Ash for Reducing the Leachability of Selenium Contained Herein

(71) Applicant: SOLVAY SA, Bruxelles (BE)

(72) Inventors: Rasik H. RAYTHATHA, Kingwood, TX (US); David Jean Lucien SAVARY, Dombasle-sur-Meurthe (FR)

(21) Appl. No.: 14/646,546

(22) PCT Filed: Dec. 5, 2013
(86) PCT No.: PCT/EP2013/075651

§ 371 Date: May 21, 2015

Related U.S. Application Data
(60) Provisional application No. 61/733,521, filed on Dec. 5, 2012.

(51) Int. Cl. A62D 3/33; B09B 3/00

(52) U.S. Cl. CPC A62D 3/33; B09B 3/0041; B09B 3/0008; A62D 2101/08

(57) ABSTRACT

A treatment method for reducing the leachability of selenium contained in a sodic fly ash which is provided by a combustion process when a sodium-based sorbent comes in contact with a flue gas generated by combustion to remove at least a portion of pollutants contained in the flue gas. The method comprises: (a) contacting the sodic fly ash with at least one additive in the presence of water; and (b) drying the material (preferably a paste) from step (a) to form a dried matter. The additive may comprise at least one strontium-containing compound, at least one barium-containing compound, dolomite, a dolomite derivative such as calcined or hydrated dolomite, at least one silicate-containing compound, or any combinations of two or more thereof. A particularly suitable additive may comprise strontium chloride, strontium hydroxide, pulverized dolomitic lime, sodium silicate, or any combinations of two or more thereof.

### CROSS-REFERENCE TO RELATED APPLICATIONS

The present application claims priority to U.S. Provisional Application No. 61/733,521 filed Dec. 5, 2012, the whole content of this application being incorporated herein by reference for all purposes.

### TECHNICAL FIELD OF THE INVENTION

This invention relates to the treatment of sodic fly ash to reduce the leachability of selenium contained herein, wherein the sodic fly ash is provided in a combustion process utilizing a sodium-based sorbent pollution control system, particularly utilizing a dry sorbent comprising sodium carbonate, sodium bicarbonate, and/or sodium sesquicarbonate (or trona) in a coal combustion process for power generation.

### BACKGROUND OF THE INVENTION

Emissions regulations in the United States have resulted in changes to coal-based electric generating plants through the addition of emission controls.

During combustion of coal in coal-fired systems, combustion products/byproducts are generated and entrained in exhaust gases, sometimes referred to flue gases. These combustion byproducts include fly ash comprising lightweight particulate matter; and gaseous compounds such as sulfur dioxide (SO₂), sulfur trioxide (SO₃), hydrochloric acid (HCl), and hydrofluoric acid (HF). These gaseous combustion byproducts may become air pollutants if emitted to the atmosphere. Control of SO₂/SO₃ emissions (commonly referred to as ‘SOx’ emissions) and HCl/HF emissions requires removal of these gaseous compounds from flue gases prior to release of the flue gases into the environment. Many materials have been employed to treat the flue gases. The physical nature of these materials varies from wet scrubbing to injection of dry powdered materials and is dependent upon the overall pollution control process system employed.

The gaseous combustion byproducts are generally acidic, and thus slurries or dry materials used to remove (“scrub”) them from the flue gases are alkaline. Wet removal systems (referred to as ‘scrubbers’) used for flue gas desulfurization typically utilize aqueous slurries of lime-based reagents (e.g., calcium oxide) or limestone to neutralize the sulfurous and/or sulfuric acids produced from the dissolution and subsequent oxidation of flue gas in scrubbers. The reaction taking place in wet scrubbing of SO₂ using a CaCO₃ (limestone) slurry or a lime-based slurry (Ca(OH)₂) produces CaSO₃ (calcium sulfite).

When using wet scrubbers employing limestone slurries or lime-based reagents, large volumes of waste product are produced and must be hauled away for disposal. Such practice is common among power plants located in areas where landfill space is abundant or is a cost-effective disposal alternative.

Recently, other alkali materials have gain acceptance in lieu of or in addition of lime-based reagents and limestone which offer flexibility and versatility in the operation of emission controls, maintenance and waste disposal requirements of flue gas desulfurization scrubber systems. These other materials are typically more expensive, but also more efficient, than lime and limestone and are more often used:

1. where the volume of waste gas to be treated is small (compared to those from large power plants);
2. where other factors such as transportation cost of the alkali material is economical;
3. where required or necessitated by local or regional regulatory constraints; or
4. where any combination of these and other economic, technical, or regulatory issues make this alternative economically and environmentally viable.

Some of these alternative alkali materials used in flue gas treatment are dry sodium-based sorbents which include sodium carbonate (Na₂CO₃), sodium bicarbonate (NaHCO₃), sodium sesquicarbonate (Na₂CO₃.NaHCO₃.2H₂O), combinations thereof, or minerals containing them such as trona, nahcolite.

Trona, sometimes referred to as sodium sesquicarbonate (Na₂CO₃.NaHCO₃.2H₂O) due to its high content in sodium sesquicarbonate (typically 70-99 wt %), is a natural mineral and is receiving increased widespread use in dry flue gas treatment systems. Nahcolite, sometimes referred to as sodium bicarbonate (NaHCO₃), is also a natural mineral which may be used in dry or slurry flue gas treatment systems.

For dry sorbent injection, dry powdered sodium-containing sorbent (such as particulate trona or sodium bicarbonate) is injected into an air duct through which a flue gas stream (containing combustion solid matter and gaseous acidic combustion byproducts) flows. The acidic gases and the sodium-containing sorbent (e.g., trona or sodium bicarbonate) react to form treatment byproducts. The solid components of the treated flue gas including combustion solid matter, treatment by-products (which may be solid sodium salts and/or may be adsorbed/absorbed on the combustion solid matter), and optionally any unreacted sodium-containing sorbent (when a stoichiometric excess is used) are removed from the flue gas stream using a particulate recovery system such as one or more baghouse filters or preferably one or more electrostatic precipitators (ESP) to collect solids referred to as a ‘sodic fly ash’ and to recover a DSI-treated flue gas stream which may be further subjected to a wet scrubber to further remove remaining acid gaseous combustion byproducts.

Whenever possible, fly ash resulting from the combustion of coal (‘coal fly ash’) which is collected from the particulate recovery system may be used in various applications; otherwise it is disposed into a landfill.

In 2006, U.S. coal-fired power plants have generated 72 million tons of fly ashes. Almost 45% of these solid residues (32 million tons) are used in a dozen of applications. According to AMERICAN COAL ASH ASSOCIATION, “2006 Coal Combustion Product (CCP)—Production and Use Survey”, among these applications,
15 million tons in concrete/concrete products/grout;
7 million tons in structural fills/embankments; and
4 million tons in cement/raw feed for clinker.

One example of a flue gas desulfurization treatment using a sodium-based dry sorbent injection technology is described in U.S. Pat. No. 7,854,911 by Maziuk. Maziuk describes the chemical reaction of trona with SO₂, which unlike sodium bicarbonate, melts at elevated temperatures. According to Maziuk, trona (mainly sodium sesquicarbonate) undergoes rapid calcination of contained sodium bicarbonate to sodium carbonate when heated at or above 275° F. Maziuk suggests that the “popcorn like” decomposition creates a large and reactive surface by bringing unreacted sodium carbonate to the particle surface for SO₂ neutralization. The byproduct of the reaction is sodium sulfate and is collected in the fly ash. The chemical reaction of the trona with the SO₂ is represented below:

2[Na₂CO₃.NaHCO₃.2H₂O]→3Na₂CO₃+5H₂O+CO₂

Na₂CO₃+SO₂→Na₂SO₃+CO₂

Na₂SO₃+½O₂→Na₂SO₄

Other reactions with trona when injected into flue gas of a coal-fired power plant, may include a reaction with hydrochloric acid according to the following:

[Na₂CO₃.NaHCO₃.2H₂O]+3HCl→3NaCl+4H₂O+2CO₂

The solid reaction products of the trona and the acid gases (e.g., SO₂, SO₃, HF, HCl) which are primarily sodium salts (e.g., sodium sulfate, sodium sulfite, sodium fluoride, and/or sodium chloride) as well as unreacted sodium carbonate are then collected in one or more particulate collection devices, such as baghouse filter(s) or electrostatic precipitator(s).

For example, trona may be maintained in contact with the flue gas for a time sufficient to react a portion of the trona with a portion of the SO₃ to reduce the concentration of the SO₃ in the flue gas stream. For SO₃ removal, the total desulfurization is preferably at least about 70%, more preferably at least about 80%, and most preferably at least about 90%.

Therefore, sodic fly ashes resulting from flue gas acid gas removal treatment which predominately use powdered trona or sodium bicarbonate as sodium-based sorbent in DSI systems contain not only fly ash particles coated and intermixed with sodium salts (e.g., sodium sulfite, sulfate, chloride, and/or fluoride) and unreacted sodium-based sorbent, but also contain various metallic compounds and other chemical attributes that may pose an environmental concern if the sodic fly ashes are placed in a landfill or used for beneficial re-use.

Even though trona or sodium bicarbonate use for acid gas removal from flue gases of coal-fired power plants has been helpful to address regulatory constraints in the United States, these sodium-based sorbents have modified the physical and chemical characteristics of the fly ashes with two consequences which are as follows:
the leaching of trace elements (such as Se) and soluble matter increases with sodium content: it raises the question of its impact on the environment (environmental storage management, surface and ground water quality, human health . . . ), and
the high content of water-soluble sodium salts may certainly prevent from the possible valorization of the sodic fly ashes into concrete if done without any further treatment (Standard ASTM-C-618: as a pozzolanic additive, fly ash must not content more than 1.5 wt % of Na₂O) and also raises the issue of its storage.

Resulting from the introduction of the sodium-based sorbent, some water-soluble sodium-heavy metal complexes, compounds, and the like, may be formed, when heavy metals contained in the flue gas get in contact with the sodium-based sorbent. As the formation of water-soluble matter with fly ash trace elements (such as Se) increases with sodium content, so does the leachability of some of these trace elements from the sodic fly ash.

In particular, the content of selenium (Se) in an untreated trona-based fly ash provided by coal combustion is usually above the regulatory limits, and such sodic coal fly ash must be treated prior to land disposal or beneficial re-use. For example, the maximum acceptable leachate concentration for selenium into a RCRA Subtitle D landfill is one (1) mg/L.

Selenium is a difficult metal to treat because selenium (Se) exhibits a variety of oxidation states. In an alkaline environment under slightly oxidizing conditions, the selenate (Se⁺⁴, SeO₄⁻²) ion predominates. Conversely, in an acidic environment that is still oxidizing, the selenite (Se⁺³, SeO₃) ion predominates. Selenate is significantly mobile in soils with little adsorption of the selenate ion over a pH range of 5.5-9.0. Therefore, selenium mobility is favored in oxidizing environments under alkaline conditions. As a result, the concentration and form of selenium is governed by pH, redox, and matrix composition (e.g., soil, ash) and makes short term and long term treatment difficult in various environments, but particularly difficult for sodic fly ash at elevated pH when excess sodium-based sorbent such as trona (Na₂CO₃.NaHCO₃.2H₂O) is used in flue gas treatment.

Water-soluble heavy metal compounds (such as selenate and/or selenite) may be detrimental if they leach from the fly ash. Hence here lies a dilemma for the power plant operators. On one side, one needs to reduce the amounts of gaseous pollutants emitted by combustion processes (such as coal-fired power plants), while due to the nature of the fuel necessitating chemical treatments for pollutant control, there is an increased generation of combustion wastes containing heavy metals such as Se and resulting in an increase need in disposal of solid wastes obtained therefrom.

### SUMMARY OF THE INVENTION

The present invention relates to a method for treating a sodic fly ash which is provided by a combustion process in which a sodium-based sorbent comes in contact with a flue gas generated by combustion to remove at least a portion of pollutants contained in the flue gas. The method for treating a sodic fly ash aims to reduce the leachability of selenium contained within such fly ash.

Such method is particularly useful for treating a fly ash generated in a coal-fired power plant.

In particular embodiments, the present invention relates to the treatment of a coal fly ash generated in a coal-fired power plant in which a dry sorbent is injected into a flue gas generated by combustion of coal in order to remove at least a portion of pollutants contained in the flue gas. The sorbent used for pollutants removal from the flue gas preferably comprises a sodium-containing sorbent, whereby the fly ash is a sodic fly ash which contains at least one sodium compound.

A particular aspect of the present invention relates to a method for reducing the leachability of selenium contained in a sodic fly ash, wherein the sodic fly ash is provided by a combustion process in which a sorbent comprising a sodium-containing sorbent is in contact with a flue gas generated during combustion to remove at least a portion of pollutants contained in the flue gas, such method comprising:

(a) contacting said sodic fly ash with at least one additive in the presence of water, wherein the at least one additive comprises at least one strontium-containing compound; at least one barium-containing compound; dolomite; one or more dolomite derivatives (like dolomitic lime, selectively calcined dolomite, and/or hydrated dolomite); at least one silicate-containing compound; or any combinations of two or more thereof; and
(b) drying the material resulting from step (a) to form a dried matter.

The sodic fly ash is preferably a sodic coal fly ash provided by a coal combustion process in which a dry sorbent comprising a sodium-containing sorbent is injected into the flue gas generated by coal combustion to remove at least a portion of pollutants (preferably acid gases, such as SOx, HCl, HF) contained in the flue gas.

In such method, the additive preferably comprises at least one strontium-containing compound, dolomite, a dolomite derivative (such as dolomitic lime, hydrated dolomite), sodium silicate, or any combinations of two or more thereof.

The contacting may comprise mixing the sodic fly ash and an aqueous solution or slurry or suspension comprising the at least one additive with optionally additional water or an acidic solution; may comprise mixing water or an acidic solution with a dry blend comprising the at least one additive in solid form and the sodic fly ash; and/or may comprise spraying an aqueous solution or slurry or suspension containing the at least one additive onto said sodic fly ash with optionally additional water or an acidic solution.

The method may comprise first dispersing or dissolving the at least one additive into water or an acidic solution to form an aqueous suspension, slurry or solution containing the at least one additive before contacting, when contacting comprises mixing the resulting aqueous dispersion, slurry, or solution and said sodic fly ash and/or spraying the resulting aqueous dispersion, slurry, or solution onto said sodic fly ash.

The method may comprise first dry mixing the at least one additive in solid form and the sodic fly ash to form a dry blend before contacting, wherein contacting comprises mixing water or an aqueous medium (e.g., acidic solution) with such dry blend.

The foregoing paragraphs have been provided by way of general introduction, and are not intended to limit the scope of the following claims. The presently preferred embodiments, together with further advantages, will be best understood by reference to the following detailed description.

### DETAILED DESCRIPTION OF THE PREFERRED EMBODIMENTS

### Definitions

The terms “heavy metals” as used herein, refer generally to elements including, for example, arsenic, selenium, antimony, beryllium, barium, cadmium, chromium, lead, nickel and zinc. As used herein, these terms encompass the elemental form of these metals as well as organic and inorganic compounds and salts containing them. Many of these elements and compounds thereof are harmful to human, animal and/or aquatic life.

The term “solubility” refers to the water solubility of a compound in water or an aqueous solution, unless explicitly stated otherwise.

As used herein, the term ‘additive’ refers to a chemical additive.

As used herein, the term “trona” includes any source of sodium sesquicarbonate.

The term “flue gas” includes the exhaust gas from any sort of combustion process (including combustion of coal, oil, natural gas, etc.).

As used herein, the term “pollutants” in a flue gas includes acid gases such as SO₂, SO₃ (altogether typically termed SOx), HCl, HF, and NO and some heavy metals which may be in a vaporized form.

As used herein, the term “sorbent” refers to a material which upon contact with a flue gas interacts with some of the flue gas constituents (such as pollutants) so as to remove at least some of them from the flue gas. Such interaction may include sorption of at least one flue gas constituent into or onto the sorbent and/or reaction between the sorbent and at least one flue gas constituent.

The term ‘comprising’ includes “consisting essentially of” and also “consisting of”. A plurality of elements includes two or more elements.

The phrase ‘A and/or B’ refers to the following selections: element A; or element B; or combination of elements A and B (A+B).

The phrase ‘A1, A2, . . . and/or An’ with n≧3 refers to the following choices: any single element Ai (i=1, 2, . . . n); or any sub-combinations of from two to (n−1) elements chosen from A1, A2, . . . , An; or combination of all elements Ai (i=1, 2, . . . n). For example, the phrase ‘A1, A2, and/or A3’ refers to the following choices: A1; A2; A3; A1+A2; A1+A3; A2+A3; or A1+A2+A3.

In the present Application, where an element or component is said to be included in and/or selected from a list of recited elements or components, it should be understood that in related embodiments explicitly contemplated here, the element or component can also be any one of the individual recited elements or components, or can also be selected from a group consisting of any two or more of the explicitly listed elements or components. Any element or component recited in a list of elements or components may be omitted from such list. Further, it should be understood that elements and/or features of processes or methods described herein can be combined in a variety of ways without departing from the scope and disclosure of the present teaching, whether explicit or implicit herein.

The use of the singular ‘a’ or ‘one’ herein includes the plural (and vice versa) unless specifically stated otherwise.

In addition, if the term “about” or “ca.” is used before a quantitative value, the present teachings also include the specific quantitative value itself, unless specifically stated otherwise. As used herein, the term “about” or “ca.” refers to a +−10% variation from the nominal value unless specifically stated otherwise.

### Sodic Fly Ash

The fly ash which is treated in the method according to the present invention is preferably generated from a power plant, such as a coal-fired power plant. Such power plant preferably comprises one or more pollutants control processes and systems which by the use of sorbent(s) allow the removal of some pollutants from an exhaust gas (flue gas stream) generated from such power plant to meet regulatory requirements for gas emissions. When a sorbent used in a pollutants control process is sodium-based, the fly ash may be called a ‘sodic’ fly ash, particularly if the sodium content of the fly ash is greater than 1.5 wt % expressed as Na₂O. The pollutants in the flue gas generally include acid gases such as SO₂, SO₃, HCl, and/or HF. The pollutants in the flue gas may further include one or more heavy metals. The pollutants to be removed by the use of sorbent(s) are preferably SO₂ and/or SO₃; HCl; and optionally heavy metals such as mercury.

The fly ash is preferably generated by a coal-fired power plant employing at least one dry sorbent injection (DSI) technology in which at least one dry sorbent comprises or consists of one or more sodium-containing sorbents. In such process, the resulting coal fly ash contains one or more water-soluble sodium-containing compounds, such as sodium carbonate and/or sodium sulfate, and hence is preferably a ‘sodic’ coal fly ash. The sodium-containing sorbent which is used in the DSI technology to generate the sodic coal fly ash may be selected from the group consisting of sodium carbonate (Na₂CO₃), sodium bicarbonate (NaHCO₃), sodium sesquicarbonate (Na₂CO₃.NaHCO₃.2H₂O), sodium sulfite (Na₂SO₃), and any combinations thereof. Minerals containing one or combinations of these sodium compounds (such as trona, nahcolite) may be used instead of the compounds themselves.

The ‘sodic’ fly ash which is to be treated with steps (a) and (b) of the present invention comprises at least one sodium compound. The at least one sodium compound in the sodic fly ash to be treated may be selected from the group consisting of sodium carbonate, sodium sulfate, sodium sulfite, sodium bisulfite, sodium bisulfate, sodium chloride, sodium fluoride, one or more sodium compounds comprising selenium, and combinations thereof. The main water-soluble sodium components of the sodic fly ash are generally sodium carbonate, sodium sulfate, and/or sodium chloride. The sodic fly ash before contacting and drying preferably contains at least one sodium compound selected from the group consisting of sodium carbonate, sodium sulfate, sodium sulfite, sodium chloride, sodium fluoride, one or more sodium compounds containing selenium, and combinations thereof.

The sodic fly ash may have a Na content greater than 1.5 wt % expressed as Na₂O, preferably equal to or greater than 2 wt %. The sodic fly ash may have a Na content less than 50 wt % expressed as Na₂O, preferably equal to or less than 45 wt %.

In some embodiment, the sodic fly ash contains selenium in an amount of at least 2 ppm. The Se content in the sodic fly ash may be from 2 ppm to 30 ppm.

At least a portion of selenium contained in the sodic fly ash (e.g., more than 1 ppm Se) is leachable in deionized water or in dilute acidic solution if no treatment with the additive according to the present invention is carried out on the sodic fly ash.

In some embodiment, the sodic fly ash further comprises water-insoluble material comprising silicon and/or aluminum. The main water-insoluble components of the sodic fly ash may comprise silicon, aluminum, iron, and calcium measured as oxides.

### Generating Sodic Fly Ash

Some embodiments of the present invention may further include a step of generating the sodic fly ash in a process for treating a gas containing acid gas pollutants, such as preferably SOₓ, HCl, and/or HF.

The fly ash is preferably generated by a coal-fired power plant employing at least one dry sorbent injection (DSI) technology in which at least one dry sorbent comprises or consists of one or more sodium-containing sorbents.

A sodium-containing sorbent (e.g., trona or sodium bicarbonate) may be injected into a flue gas stream (e.g., generated in a coal-fired power plant), and the sodium-containing sorbent interacts with at least one of the pollutants to remove at least a portion of said pollutant(s). The injection is preferably taking place in a duct inside which the flue gas stream flows. In this process, it is recommended that the temperature of the flue gas stream is above 100° C., preferably above 110° C., more preferably above 120° C., most preferably above 130° C. At those temperatures, trona or sodium bicarbonate (or nahcolite) quickly decomposes into sodium carbonate having a high specific surface and thus high reactivity. The decomposition of these sodium-containing sorbents occurs within seconds upon exposure to such temperature, for example in the duct. The sorbent may be injected in the dry or semidry state. By ‘semidry state injection’ is understood to mean an injection of fine droplets of a water solution or preferably suspension of the sorbent (slurry) into a hot flue gas, having a temperature above 100° C. The solution or suspension evaporates immediately after its contact with the hot flue gas. The flue gas solids comprising products of the sorbent/pollutants interaction(s)—such as sorption and/or reaction(s)—can be recovered from the treated flue gas by one or more bag filters and/or one or more electrostatic precipitators to generate the sodic fly ash, a portion of which can be treated by the present method.

A suitable example for the use of sodium bicarbonate sorbent in the purification of a gas containing hydrogen chloride (such as flue gas from the incineration of household waste) may be found in U.S. Pat. No. 6,171,567 (by Fagiolini), incorporated herein by reference.

Another suitable example for the use of sodium bicarbonate in cleaning a gas containing sulfur dioxide and nitrogen monoxide (for example, fumes generated by the combustion of sulfur-containing fossil fuels, in electricity-producing power stations) may be found in U.S. Pat. No. 5,540,902 (by De Soete), incorporated herein by reference.

A suitable example for the use of trona sorbent in the purification of a gas containing sulfur dioxide may be found in U.S. Pat. No. 7,854,911 (by Maziuk), incorporated herein by reference.

A suitable example for the use of trona sorbent in the purification of a gas containing sulfur trioxide at a temperature from 500° F. to 850° F. may be found in U.S. Pat. No. 7,481,987 (by Maziuk), incorporated herein by reference.

Any of these pollutant control methods have the potential to generate a sodic fly ash which contains leachable selenium which may need to be treated according to the present invention to minimize Se leaching.

Step (a): Contacting with at Least One Additive

The method according to the present invention comprises: (a) contacting the sodic fly ash with at least one additive in the presence of water.

The additive may comprise at least one alkali earth metal-containing compound, at least one silicate-containing compound, or combinations thereof. The alkali earth metal may be Mg, Ca, Sr, and/or Ba.

A preferred additive may comprise at least one strontium-containing compound; at least one barium-containing compound; dolomite; one or more dolomite derivatives, like dolomitic lime, selectively calcined dolomite, and/or hydrated dolomite; at least one silicate-containing compound; or any combinations of two or more thereof.

A particularly preferred additive may comprise at least one strontium-containing compound, dolomite, dolomitic lime, at least one silicate-containing compound, or any combinations of two or more thereof.

A suitable strontium-containing compound may comprise, or may consist of, strontium hydroxide, strontium chloride, strontium carbonate, or combinations of two or more thereof, preferably may comprise, or may consist, of strontium hydroxide and/or strontium chloride.

A suitable barium-containing compound may comprise, or may consist of, barium hydroxide and/or barium chloride.

A suitable silicate-containing compound may comprise, or may consist of, sodium silicate and/or magnesium silicate, preferably may comprise, or may consist of, sodium silicate. The silicate-containing compound does not include silica sand.

A suitable additive comprising Mg and/or Ca may comprise, or may consist of, magnesium carbonate (magnesite), dolomite, one or more dolomite derivatives, or any combinations of two or more thereof. It is preferred that the additive does not include lime. It is even more preferred that the additive does not consist of lime.

Dolomite is a mineral (CaCO₃.MgCO₃) which contains equimolar amounts of calcium carbonate and magnesium carbonate; it generally contains a minimum of 97% total carbonate composition.

A dolomite derivative is a compound which is obtained by the partial or complete conversion of at least one or both carbonate components of dolomite to an oxide or hydroxide form. Non-limiting examples of dolomite derivatives includes dolomitic lime (also known as ‘calcined dolomite’), selectively calcined dolomite, and/or hydrated calcined dolomite (also known as ‘hydrated dolomite’). Dolomitic lime is typically resulting from calcination of dolomite. Depending on the calcination conditions used, a ‘fully calcined dolomite’ or a ‘selectively calcined dolomite’ may be obtained. Dolomitic lime typically refers to the ‘fully calcined dolomite’ in which the calcination of dolomite at a temperature in the range of 900-1200° C. produces from both of its carbonate components the corresponding oxides and CO₂ to give formula: CaO.MgO. Since the magnesium carbonate component in the dolomite decomposes to the oxide form and CO₂ at a lower temperature (ca. 600° C.) than calcium carbonate (ca. 900° C.), dolomite can be selectively calcined (e.g., ≧600 and <900° C.) to convert its magnesium component to the oxide form while keeping most of the calcium component in carbonate form thereby providing a ‘selectively calcined dolomite’ with an approximate formula MgO.CaCO₃. Hydrated dolomite is a product of slaking fully calcined dolomite, whereby calcium oxide is hydrated while magnesium oxide remains intact; hydrated dolomite therefore has an approximate formula MgO.Ca(OH)₂. A pulverized dolomitic lime (of micron-sized particles), also called ‘DLP’, is particularly suitable as a source for additive.

A particularly suitable additive containing Mg and Ca may comprise, or may consist of dolomite, dolomitic lime, hydrated dolomite, or any combinations of two or more thereof.

A preferred additive may comprise, or may consist of, at least one compound selected from the group consisting of strontium hydroxide, strontium chloride, sodium silicate, dolomitic lime, and any combinations of two or more thereof.

A particularly advantageous additive is sodium silicate or a combination of sodium silicate with a compound selected from the group consisting of strontium hydroxide, strontium chloride, dolomitic lime, and any combinations thereof.

When the additive is in powder or particulate form prior to contact with the sodic fly ash, its average particle size is generally less than 500 microns, preferably less than 250 microns, more preferably less than 150 microns. One of the advantages of a small particle size for a water-soluble additive is that the dissolution of such additive is faster in water. For this reason, the use of a particulate additive with submicron (e.g., nanosized) particles is also envisioned.

In some embodiments, the additive does not contain a phosphate-containing compound and/or a phosphoric acid-containing compound. In particular, the additive preferably does not contain orthophosphoric acid or any of its alkali metal/alkali earth metal salts.

In some additional or alternate embodiments, the additive does not contain a sulfide-containing compound, such as sodium sulfide Na₂S.

In some additional or alternate embodiments, the additive does not contain an iron-containing compound, such as ferric sulfate Fe₂(SO₄)₃.

In some additional or alternate embodiments, the additive does not contain sodium oxide (Na₂O), calcium chloride, and/or ammonium chloride.

In preferred embodiments, the additive excludes a phosphate-containing compound, a phosphoric acid-containing compound (including orthophosphoric acid), a sulfide-containing compound, sodium oxide (Na₂O), calcium chloride, ammonium chloride, and an iron-containing compound.

The content of the additive can vary over a wide range.

The amount of the additive is preferably sufficient to achieve at least a 50%, or at least 60%, or at least 75%, reduction in Se leachability from the sodic fly ash.

The amount of the additive may be sufficient to achieve a Se leachability from the treated material of 1 ppm or less.

The content of the additive is usually higher than or equal to 0.1 percent based on the weight of the sodic fly ash, preferably higher than or equal to 0.5 wt %, more preferably higher than or equal to 1 wt %, and most preferably higher than or equal to 2 wt %. The content of the additive is generally lower than or equal to 20 wt %, advantageously lower than or equal to 15 wt %, more advantageously lower than or equal to 10 wt %, and most advantageously lower than or equal to 5 wt %. A range from 2 wt % to 5 wt % for the additive is particularly advantageous.

The molar ratio of additive to selenium is typically higher than 1:1. The molar ratio of additive to selenium may be from 2:1 to 100:1 or even more.

The contacting takes place in the presence of at least some water. Contacting does not include dry contact between the fly ash and any additive without presence of water. The sodic fly ash and at least one additive may be dry blended but in this instance, contacting is initiated when water is added to the dry blend.

In some embodiments, the sodic fly ash is characterized by a liquid holding capacity. The amount of water used during contacting in step (a) may be lower than the liquid holding capacity of said sodic fly ash. In alternate embodiments, the amount of water used during contacting in step (a) may be equal to or higher than the liquid holding capacity of said sodic fly ash but not exceeding 75%. The amount of water used during contacting in step (a) is preferably within +/−5 wt %, more preferably within +/−3 wt %, most preferably within +/−2 wt % of the liquid holding capacity of the sodic fly ash.

In some embodiments, the water content used during contacting in step (a) is such that the material resulting from step (a) is a soft malleable paste. The paste may contain at most 50 wt % water or even at most 40 wt % water, preferably at most 35 wt % water, more preferably may contain between 20 wt % and 35 wt % water, most preferably between 30 wt % and 35 wt % water.

In some embodiments, the contacting step is carried out under an acidic pH of from 3 to 7, or under near-neutral pH of from 6 to 8. Since a water-soluble sodium compound such as sodium carbonate is typically present in the sodic fly ash, the material obtained after contact in step (a) with deionized water would have an alkaline pH (ca. 10-12); in such case, an acidic solution (e.g., a dilute HCl acidic solution) may be used instead of deionized water during the contacting step.

Various techniques for achieving contact between the sodic fly ash and the additive(s) may be used.

Mixing the additive(s) and the sodic fly ash, such as, without being limiting, kneading, screw mixing, stirring, or any combinations thereof may be used for contacting. Such mixing may be carried out in the presence of water. Spraying an additive onto a mass of sodic fly ash may be an alternate or additional technique for contacting. Such spraying may be carried out in the presence of water.

In some embodiments, the method may comprise first dry mixing the at least one additive in solid form (such as powder or granules) and the sodic fly ash to form a dry blend, and then adding water to such dry blend for initiating contacting.

Dry mixing (solid/solid mixing) may be carried out using a tumbling or convective mixer or any mechanical device in which a carrier liquid (e.g., water, organic solvent) is not required for mixing. A suitable tumbling mixer may be selected from the group consisting of a drum blender, a V-blender, a bin blender, and a double-cone blender. A suitable convective blender generally comprises a stationary vessel swept by a rotating impeller, and may be selected from the group consisting of a ribbon blender (a cylindrical vessel with a helical ribbon impeller mounted on a horizontal shaft), a paddle blender (a modified ribbon blender with paddles instead of a helical ribbon), a Nauta blender (a vertically oriented conical tank swept out by a rotating and precessing screw impeller), a Forberg mixer (two paddle blender drives sweeping two connected troughs), a Z-blade blender (a cylindrical vessel swept out by a Z-shaped blade), and a Lodige mixer (similar to a kitchen mixer where plough-shaped shovels rotate a cylindrical drum). The dry mixing of the at least one additive in solid form and the sodic fly ash is preferably carried out in a mixer selected from the group consisting of a ribbon blender and a V-blender.

In embodiments wherein the method comprises forming a dry blend containing the additive(s) (in solid form) and the sodic fly ash, the contacting step preferably comprises mixing water or an acidic solution with the dry blend. Such contacting step involves wet mixing.

In preferred embodiments of the present invention, the method may comprise first dispersing or dissolving the additive(s) into water or in an acidic solution to form an aqueous suspension, slurry or solution containing the additive(s) and then contacting the sodic fly ash with the resulting aqueous dispersion, slurry, or solution comprising the at least one additive. This contacting step may involve wet mixing, spraying, or combination of wet mixing and spraying.

In embodiments wherein the method comprises forming an aqueous suspension, slurry or solution containing the additive(s), the contacting step preferably comprises mixing the sodic fly ash and the aqueous solution or slurry or suspension containing the additive(s) with optionally additional water or an aqueous medium (e.g., acidic solution). This contacting step involves wet mixing.

Wet mixing (solid/liquid mixing) may be carried out using a mixer selected from the group consisting of a kneading mixer, a screw mixer, a cone mixer, a plow mixer, a ribbon blender, a pan Muller mixer, a stirring tank, a helical-blade mixer, an extruder (such as a Rietz, single-screw, or double-screw extruder), and any combinations thereof. Any mixer being suitable for paste mixing or viscous material mixing would be suitable for wet mixing according to such embodiment of the present invention.

In some additional or alternate embodiment wherein the method comprises forming an aqueous suspension, slurry or solution containing the additive(s), the contacting step may comprise spraying the aqueous solution or slurry or suspension containing the additive(s) onto the sodic fly ash with optionally additional water or an aqueous medium (e.g., acidic solution).

The sodic fly ash mass may be in motion during spraying to allow even distribution of additives(s) onto the sodic fly ash mass. For example, the mass of sodic fly ash may be in motion on a moving surface (e.g., conveyor), in motion due to the rotation of a ribbon, screw or blade, or tumbling in a rotating vessel while the solution or suspension or slurry comprising one or more additives is sprayed onto the moving sodic fly ash mass.

It is envisioned that more than one contacting technique may be employed during step (a) for contacting the sodic fly ash with the same additive or for contacting the sodic fly ash with different additives.

It is also envisioned that the same contacting technique may be employed during step (a) for contacting the sodic fly ash with different additives, either simultaneously or sequentially.

Contacting may take place for a time period of no less than 10 minutes and/or of no more than 12 hours. Contact time between 15 minutes and 1 hour is generally suitable.

Contacting may take place at a temperature of less than 50° C. A temperature greater than 0° C. and less than 50° C., preferably between 4 and 45° C., more preferably between 10 and 30° C., would be suitable for this contacting step.

In preferred embodiments, step (a) excludes a phosphatation and/or a sulfidation.

In alternate embodiments, step (a) may further include a phosphatation by using a phosphate-containing compound as a further additive. The phosphatation may be carried out at the same time as during contacting in step (a). The phosphatation and the contacting in step (a) may be carried out sequentially.

In other embodiments, step (a) may further include a sulfidation by using a sulfide-containing compound (e.g., Na₂S) as a further additive. The sulfidation may be carried out at the same time as during contacting in step (a). The sulfidation and the contacting in step (a) may be carried out sequentially.

Before carrying out the drying in step (b), the material obtained during contacting may be optionally formed into shapes, for example extruded or molded into one or more forms such as in the form of pellets, granules, bricks, briquettes, or the like.

### Step (b): Drying

In some embodiments of the present invention, drying in step (b) may be carried out at a temperature of more than 100° C. and/or less than 150° C. The objective of the drying step (b) is to remove the water from the material which is resulting from the contacting step (a).

Drying time will vary depending on the amount of water used during step (a). Drying time is typically at least 5 minutes, preferably at least 30 minutes, and at most 12 hours. A drying time between 20 minutes and 6 hours is suitable when the water content in the material obtained in step (a) is between 20 and 40 wt %. A drying time between 30 minutes and 3 hours is preferred.

Drying preferably takes place in air, but may take place under an inert (non-reactive) atmosphere such as nitrogen.

Drying may be indirect drying in which a heat transfer fluid having a temperature greater than the material to be dried is heating a surface and the material to be dried is then dried by contact with the heated surface (but without being in contact with the heat transfer fluid).

Drying may be direct drying in which a fluid having a temperature greater than the material to be dried (such as hot air) is brought in contact with the material to be dried.

Drying may take place at atmospheric pressure or under vacuum to facilitate the removal of water from the material to be dried.

The drying in step (b) is preferably carried out without calcining or sintering the contacted material resulting from step (a). In particular, drying excludes heating the material obtained from step (a) at a temperature exceeding 500° C. Preferably, drying in step (b) should not comprise conditions which favor the volatilization of heavy metals (such as Se) contained in the contacted material resulting from step (a).

The dried matter may contain less than 50% of leachable selenium than the initial sodic fly ash before the treatment with the additive.

The dried matter resulting from step (b) preferably contains 1 ppm or less of leachable Se.

In some embodiments, the method may comprise successive contacting steps (aₙ) with optionally one or more drying or partial drying steps (b′) carried out between contacting steps (aₙ), and a final drying step (b). The additive(s) used in the contacting steps (aₙ) may be the same additive applied in several portions or may be different additives. The successive contacting steps (aₙ) may employ the same contacting technique; or different contacting techniques may be used in successive contacting steps (aₙ).

In some particular embodiments in which two or more additives are contacted with the sodic fly ash in separate contacting steps (aₙ), the method may comprise:

(a1) contacting the sodic fly ash with a first additive in the presence of water,
(b′) optionally drying the contacted material resulting from step (al) to form a first partially-dried or dried matter;
(a2) contacting the contacted sodic fly ash resulting from step (al) or the partially-dried/dried matter formed in optional step (b′) with a second additive optionally in the presence of additional water;
(b) drying the material resulting from step (a2) to form a final dried matter;

wherein the first and second additives are different, and each additive may comprise at least one strontium-containing compound; at least one barium-containing compound; dolomite; one or more dolomite derivatives (such as, dolomitic lime, selectively calcined dolomite, and/or hydrated dolomite); at least one silicate-containing compound; or any combinations or two or more thereof.

The techniques for contacting in steps (a1) and (a2) may be the same or different. The optional additional water in step (a2) may be in the form of pure water or an aqueous medium (e.g., an acidic solution).

In some alternate embodiments in which the same additive is contacted with the sodic fly ash using more than one contacting step (a), the method may comprise:

(a1′) contacting the sodic fly ash with a first portion of an additive in the presence of water,
(b′) optionally drying the material resulting from step (a1′) to form a partially-dried or dried matter;
(a2′) contacting the contacted sodic fly ash resulting from step (a1′) or the partially-dried/dried matter formed in optional step (b′) with a second portion of the same additive optionally in the presence of additional water;
(b) drying the material resulting from step (a2′) to form a final dried matter;

wherein the additive may comprise at least one strontium-containing compound; at least one barium-containing compound; dolomite; one or more dolomite derivatives (such as, dolomitic lime, selectively calcined dolomite, and/or hydrated dolomite); at least one silicate-containing compound; or any combinations or two or more thereof; and

wherein the contacting steps (a1′) and (a2′) may use the same contacting technique or different contacting techniques.

The optional additional water in step (a2′) may be in the form of pure water or an aqueous medium (e.g., an acidic solution).

The present invention having been generally described, the following Examples are given as particular embodiments of the invention and to demonstrate the practice and advantages thereof. It is understood that the examples are given by way of illustration and are not intended to limit the specification or the claims to follow in any manner.

### EXAMPLES

### Example 1

### Determination of Se Content in Various Sodic Fly Ashes

Three sodic fly ashes A, B, C from coal fired plants using a dry sorbent injection system employing sodium bicarbonate or trona for acid gas mitigation were analyzed for contents in sodium-containing compounds and in Se. The results are shown in TABLE 1.

| | | Sodic | Sodic | Sodic |
|---|---|---|---|---|
| | Unit | Fly Ash A | Fly Ash B | Fly Ash C |
| Sorbent used in | — | trona | Sodium | trona |
| DSI system | | | bicarbonate | |
| Water-soluble | g/kg fly ash | 69 | 33 | 324 |
| Fraction | | | | |
| Na₂SO₄ | g/kg fly ash | 37 | 25 | 135 |
| Na2CO₃ | g/kg fly ash | 33 | 7 | 180 |
| NaHCO₃ | g/kg fly ash | 0 | 1 | 5 |
| Expressed as | wt % | 3.5 | 1.5 | 16.6 |
| Na₂O | | | | |
| Water-insoluble | g/kg fly ash | 931 | 967 | 676 |
| Fraction | | | | |
| SiO₂ | g/kg insolubles | 520 | 480 | 471 |
| Al₂O₃ | g/kg insolubles | 220 | 190 | 265 |
| CaO | g/kg insolubles | 130 | 110 | 21 |
| Fe₂O₃ | g/kg insolubles | 59 | 52 | 70 |
| Se* | mg/kg fly ash | 4.5 | 2.6 | 15.5 |

*measured by Atomic Absorption

Main insoluble elements expressed under their oxide form, were silica, alumina, iron oxide, and calcium oxide. These main elements represented from 82 to 93% of the water-insoluble portion of the fly ashes.

The sodic fly ashes A and B contained between 1.5 wt % and 3.5 wt % of

Na₂O. Even if these values were low, they were equal to or exceeded standard specifications for pozzolans from fly ash (ASTM-C-618: maximum available alkalis: [Na₂O]=1.5 wt %), and neither sodic fly ashes A and B could be valorized in the concrete industry.

The fly ash sample C contained a high amount of water-soluble material, about 32 wt %, ([Na₂O]=16.6 wt %) and could not be valorized into concrete.

### Example 2

### Leaching Tests with Sodic Fly Ashes without Treatment with Additive

Two types of leaching tests were performed for the sodic fly ashes A, B, C of Example 1.

Sodic fly ashes A and B were leached according to European Standard NF-EN-12457-2 in which leaching was carried out with demineralized water with a Liquid to Solid ratio L/S=10 mL water/g solid during 24 hours (using 90 grams of fly ash and 900 grams of demineralized water).

Results are shown in TABLE 2. Without treatment according to the present invention, Se leaching from these fly ashes was high (57-101%) at a high alkaline pH of about 12.

### European Standard NF EN 12457-2 Leaching Test: Summarized Protocol

1. 95% of the solid must pass through a 4 mm (0.4 mesh) sieve; if more than 5% does not pass, the fraction above 4 mm must be crushed in a jaw crusher;
2. Prepare the mixture fly ash with demineralized water:
   a. ‘m’ fly ash corresponding to ‘m’ dry solid=0.090+/−0.005 kg
   b. L/S ratio=10 L leaching agent/kg dry solid+/−2%;
3. Mix during 24+/−0.5 hours in a rotating vessel at 5-10 turns/min and T=20+/−5° C.;
4. At the end of the leaching, extract the content of the rotating vessel;
5. Leave it settle during 15+/−5 min;
6. Filtrate on a membrane filter 0.45 μm under vacuum (−300 to −700 mbar) or under pressure (<5 bar) and measure the eluate volume, the conductivity, temperature, pH, and redox potential;
7. Analyze the content of the eluate;
8. In parallel, make a “blank trial”, with 0.95 L of leaching agent without any solid and follow the previous operating protocol. Analyze the content of the blank eluate.

TABLE 2

| | | Sodic | Sodic |
|---|---|---|---|
| | Unit | Fly Ash A | Fly Ash B |
| Sorbent used | — | trona | Sodium |
| in DSI system | | | bicarbonate |
| Se* in fly ash | mg/kg fly ash | 4.5 | 2.6 |
| Solubilized Se from | mg/kg fly ash | 4.6 | 1.5 |
| fly ash | | | |
| % solubilized Se | % | 101% | 57% |
| compared to initial Se | | | |
| pH at end | | 12.3 | 11.9 |
| of leaching test | | | |

*measured by Atomic Absorption Spectroscopy

Sodic fly ashes A, B and C were leached according to the U.S. Standard Method EPA 1311 from EPA Manual SW 486: TCLP (Toxicity Characteristic Leaching Procedure) in which leaching was carried out with an acetic acid solution with a Liquid to Solid ratio L/S=20 g water/g solid during 18 hours (using 50 grams of fly ash and 1000 grams of diluted acetic acid solution of pH=2.88). Results for TCLP leaching tests are shown in TABLE 3.

American Standard: Method EPA 1311 from EPA Manual SW 4861: TCLP (Toxicity Characteristic Leaching Procedure):
1. Pass the solid through a 10 mm (1.4 mesh) sieve; if necessary, reduce the granulometry of the solid by grinding or de-agglomeration;
2. Determine the leaching agent No. 1 or 2 to be used:
   Leaching agent 1: in a 1-L volumetric flask, add 500 mL water+5.7 mL glacial acetic acid+64.3 mL NaOH 1 mol/L and adjust the level with water
   Leaching agent 2: in a 1-L volumetric flask, add 5.7 mL glacial acetic acid (pure, water free) and adjust the level with water
a. Add 5.0 g of solid into 96.5 mL water in a 500-mL Erlenmeyer flask; stir with a magnetic stirrer during 5 min.;
b. Measure the pH:
i. If pH<5.0, use the leaching agent No. 1 (pH=4.93)
ii. If pH>5.0: add 3.5 mL HCl 1 mol/L, stir briefly, heat up at 50° C. and maintain the heating 10 min., then leave to cool down, and measure the pH:
1. If pH<5.0, use the leaching agent 1 (pH=4.93)
2. If pH>5.0, use the leaching agent 2 (pH=2.88)
3. Weigh 100+/−0.1 g of sample and put it into the rotating vessel;
4. Slowly add the leaching agent so as to reach a Liquid to Solid ratio of 20 g/g solid sample;
5. Close the vessel, fix it on a twin-shell blender;
6. Run the leaching at a speed of 30+/−2 turns/min during 18+/−2 hours at a temperature of 23+/−2° C.;
7. If the solid sample contain carbonates, the vessel can be open periodically to evacuate the overpressure;
8. After the test, filtrate on a 0.6-0.8 μm filter and measure the pH of the filtrate;
9. Divide the leachates for further analyses and conservation (T<4° C.);
10. For the analysis of metals, acidify the leachates at pH<2 with HNO₃ 1 mol/L;
11. Analyze the content of the eluate;
12. In parallel, after 20 leaching tests, make a “blank trial” without any solid and follow the previous operating protocol. Analyze the content of the blank eluate.
13. Between the sampling of the solid and the final analysis of the leachates, the duration must not exceed 28 days for volatile compounds, 61 days for semi-volatile compounds, 56 days for mercury, and 360 days for other metals.

TABLE 3

| | | Sodic | Sodic | Sodic |
|---|---|---|---|---|
| | Unit | Fly Ash A | Fly Ash B | Fly Ash C |
| Sorbent used in | — | trona | Sodium | trona |
| DSI system | | | bicarbonate | |
| Se* in fly ash | mg/kg fly ash | 4.5 | 2.6 | 15.5 |
| Solubilized Se | mg/kg fly ash | 0.14 | 0.2 | 14.6 |
| from fly ash | | | | |
| % solubilized Se | % | 3% | 8% | 94% |
| compared to | | | | |
| initial Se | | | | |
| pH at end | | 5.9 | 5.2 | 5.9 |
| of leaching test | | | | |

*measured by Atomic Absorption Spectroscopy

Without treatment with additive according to the present invention, Se leaching under TCLP conditions from the fly ash C was high (94%), but almost no or little Se leaching was observed under TCLP conditions for sodic fly ashes A and B.

The difference in Se leachability may be explained by the presence of different selenium species in these sodic fly ashes. TCLP test on fly ash C showed a higher percentage of solubilization than fly ashes A and B; it may be due to a different pathway of capture of Se in flue gases. For fly ashes A and B, Se in coal is oxidized into gaseous SeO₂ which is adsorbed as Se^{+IV} on the surface of small fly ashes particles. Further chemical reactions occur to chemically bind selenite species; when pH>8, HSeO₃⁻→SeO₃²⁻ (pKₐ=8.3) dianions are formed and the electrostatic repulsion between anionic species and anionic surface may cause the deadsorption of the oxyanions into the leachate. The remaining SeO₂ (gaseous or solid) would have exited at the coal-fired plant stack.

For sodic fly ash C, part of SeO₂ may have been trapped onto fly ashes surface; but while some SeO₂ may have gone out at coal plant stack, the main portion may have been neutralized by calcined trona into sodium selenates, as Se^{+VI} (neutralization of Se species with Na₂CO₃ from trona would result in reaction of acidic SeO₂, H₂SeO₃, or H₂SeO₄ to form for example Na₂SeO₄₍ₛ₎).

Sodium selenate (Se oxidation number+VI) obtained by neutralization with a sodium sorbent would be more soluble in acidic condition than the complex —FeHₓSeO₃^{x-1} (Se oxidation number+IV) which would be obtained between gaseous SeO₂ and fly ash surface. This may explain why sodic fly ash C showed higher Se leachability at a pH of 5.9, while the other two fly ashes did not.

### Example 3

### Treatment with Various Additives to Reduce Se Leachability

Determination of Liquid Holding Capacity of a Sodic Fly Ash D: The liquid holding capacity of a sodic fly ash D was measured by adding water to 20 grams of fly ash until it formed a soft malleable paste. This was found to be equivalent to 34.2% by weight of fly ash D.

Treatment: One additive was either dissolved or dispersed in 6.5 grams of deionized water. More than one additive may be dissolved or dispersed in the deionized water. This slurry or suspension was then added to 19 grams of fly ash. The resulting paste was stirred as much as possible with a spatula and allowed to dry at 110° C. for 2 hours.

The additives used in Example 3 were strontium chloride, strontium hydroxide, sodium silicate, dolomitic lime pulverized (DLP), combination of DLP and sodium silicate, and combination of strontium chloride and sodium silicate.

The sodium silicate solution (40-42 degree Baume) was obtained from Aqua Solutions (Deer Park, Tex.).

The dolomitic lime pulverized with ca. 4-micron sized particles was from Grupo Calider, Monterrey, Mexico.

To prepare the strontium chloride additive, 0.93 g (or 0.37 g) of strontium carbonate (Solvay CPC Barium Strontium Monterrey standard grade) using 0.6 g (or 0.24 g) concentrated HCl were diluted to 6.5 g with deionized water. A portion of this solution was added to 19 g of fly ash to reach a content of 5 wt % (or 2 wt %) SrCl₂.

Strontium Hydroxide was supplied by Solvay CPC Barium Strontium, Monterrey. In addition, to freshly prepare the strontium hydroxide additive, strontium sulfide (SrS) was mixed with sodium hydroxide, and a selective precipitation of strontium hydroxide took place which allowed the recovery of strontium hydroxide from sodium sulfide (Na₂S). The obtained strontium hydroxide was then diluted with water to add to a fly ash sample to be treated.

Extraction (leaching test): 18 grams of the resulting dried treated material was dispersed in 100 grams of deionized water or diluted hydrochloric acid solution (7 g HCl in 93 g water) of a pH of about 3.5. The resulting slurry was stirred with a magnetic stirrer for 10 minutes. The slurry was filtered with a syringe filter using 0.1-micron Whatman membrane filter. This clear extract was used directly for selenium analysis. The results on the reduction of Se leachability using the treatment method according to the present invention can be found in TABLE 4.

| | | | Se** (ppm) | % reduction in |
|---|---|---|---|---|
| Additive(s) | wt % | Extraction | extracted | Se leachability |
| — | — | Water* | 3.1 | — |
| — | — | Acidic water | 2.3 | 26.1 |
| Sr(OH)₂ | 5% | Acidic water | 1.6 | 49 |
| Sodium silicate | 5% | Acidic water | 0.54 | 83 |
| Dolomitic Lime | 5% | Acidic water | 0.46 | 86 |
| Pulverized (DLP) | | | | |
| Sr(OH)₂+ | 2% | Acidic water | 0.43 | 87 |
| Sodium silicate | 2% | | | |
| DLP + | 2% | Acidic water | 0.03 | 100 |
| Sodium silicate | 2% | | | |
| Sodium silicate | 2% | Acidic water | 0.03 | 100 |
| SrCl₂ | 5% | Acidic water | 0.03 | 100 |
| SrCl₂ + | 2% | Acidic water | 0.03 | 100 |
| Sodium Silicate | 2% | | | |

*= measured 0.03 ppm Se in extraction water
**measured by ICP

The disclosure of all patent applications, and publications cited herein are hereby incorporated by reference, to the extent that they provide exemplary, procedural or other details supplementary to those set forth herein. Should the disclosure of any of the patents, patent applications, and publications that are incorporated herein by reference conflict with the present specification to the extent that it might render a term unclear, the present specification shall take precedence.

Each and every claim is incorporated into the specification as an embodiment of the present invention. Thus, the claims are a further description and are an addition to the preferred embodiments of the present invention.

While preferred embodiments of this invention have been shown and described, modifications thereof can be made by one skilled in the art without departing from the spirit or teaching of this invention. The embodiments described herein are exemplary only and are not limiting. Many variations and modifications of systems and methods are possible and are within the scope of the invention.

Accordingly, the scope of protection is not limited by the description and Examples set out above, but is only limited by the claims which follow, that scope including all equivalents of the subject matter of the claims.

What we claimed is:

1. A method for reducing the leachability of selenium contained in a sodic fly ash, wherein the sodic fly ash is provided by a combustion process in which a sorbent comprising a sodium-containing sorbent is injected into a flue gas generated during combustion to remove at least a portion of pollutants contained in the flue gas, said method comprising:
(a) contacting said sodic fly ash with at least one additive in the presence of water, wherein the at least one additive comprises at least one strontium-containing compound; at least one barium-containing compound; dolomite; one or more dolomite derivatives; at least one silicate-containing compound; or any combination of two or more thereof; and
(b) drying the material resulting from step (a) to form a dried matter.
2. The method according to claim 1, wherein said at least one additive comprises strontium hydroxide, strontium chloride, sodium silicate, dolomite, dolomitic lime, or any combination of two or more thereof.

3. The method according to claim 1,
wherein said sodic fly ash has a Na content greater than 1.5 wt % expressed as Na₂O, and/or has a Na content of less than 50 wt % expressed as Na₂O.

4. The method according to claim 1, further comprising first dispersing or dissolving the at least one additive into water or an acidic solution to form an aqueous suspension, slurry or solution containing the at least one additive before contacting said sodic fly ash with said resulting aqueous dispersion, slurry, or solution.

5. The method according to claim 1, wherein contacting comprises mixing said sodic fly ash and an aqueous solution or slurry or suspension containing the at least one additive with optionally additional water or an acidic solution.

6. The method according to claim 1, wherein contacting comprises spraying an aqueous solution or slurry or suspension containing the at least one additive onto said sodic fly ash with optionally additional water or an acidic solution.

7. The method according to claim 1, further comprising first dry mixing the at least one additive in solid form and said sodic fly ash to form a dry blend, and wherein the contacting step comprising mixing water or an aqueous medium with said dry blend.

8. The method according to claim 1, wherein contacting in step (a) uses a water content so as to form a paste comprising the at least one additive and said sodic fly ash.

9. The method according to claim 8, wherein the paste contains at most 40 wt % water.

10. The method according to claim 1, wherein contacting is carried out under an acidic pH of from 3 to 7 or under near-neutral pH of from 6 to 8.

11. The method according to claim 1, wherein the sodic fly ash is characterized by a liquid holding capacity, and wherein the amount of water used during contacting in step (a) is within +/−5 wt % of said liquid holding capacity of the sodic fly ash.

12. The method according to claim 1, wherein contacting in step (a) takes place for a time period of no less than 10 minutes and/or of no more than 12 hours.

13. The method according to claim 1, wherein contacting in step (a) takes place at a temperature of less than 50° C.

14. The method according to claim 1, wherein drying in step (b) is carried out at a temperature equal to or more than 100° C. and/or equal to or less than 150° C.

15. The method according to claim 1, wherein the drying in step (b) is carried out without calcining or sintering the material resulting from step (a).

16. The method according to claim 1, wherein the sodium-containing sorbent is selected from the group consisting of sodium carbonate (Na₂CO₃), sodium bicarbonate (NaHCO₃), sodium sesquicarbonate (Na₂CO₃.NaHCO₃.2H₂O), sodium sulfite (Na₂SO₃), and any combination of two or more thereof.

17. The method according to claim 1, wherein the sodic fly ash before contacting and drying contains at least one sodium compound selected from the group consisting of sodium carbonate, sodium sulfate, sodium sulfite, sodium chloride, sodium fluoride, one or more sodium compounds containing selenium, and any combination of two or more thereof.

18. The method according to claim 1, wherein the dried matter obtained in step (b) contains at least 50% less leachable selenium than the sodic fly ash before contacting in step (a).

19. The method according to claim 1, wherein the dried matter resulting from step (b) has 1 ppm or less of leachable Se.

20. The method according to claim 1, wherein said at least one additive comprises strontium hydroxide, strontium chloride, sodium silicate, dolomitic lime, or a combination of sodium silicate with at least one compound selected from the group consisting of strontium hydroxide, strontium chloride, and dolomitic lime.
